(19) United States
(12) Patent Application Publication
(10) Pub. No.: US 2006/0200309 A1
(43) Pub. Date: Sep. 7, 2006

(54) Data structure of a point of interest and method for use and application of a point of interest with data structure

(76) Inventors: Hung-Chih Yu, Taipei (TW); Huan-Wen Chien, Taipei (TW)

Correspondence Address: HARNESS, DICKEY & PIERCE, P.L.C., P.O. BOX 8910, RESTON, VA, 20195, US

(21) Appl. No.: 11/339,472

(22) Filed: Jan. 26, 2006

(30) Foreign Application Priority Data
Mar. 7, 2005 (TW) 94106864

(51) Int. Cl. G01C 21/32

(52) U.S. Cl. 701/208

(57) ABSTRACT

A data structure for a point of interest (POI) and a method for use and application of POI information with the data structure, and is applied in a handheld device. The POI information for a single POI is sorted based on attributes of the POI and the sorted sets of POI information are included in folders, file names or POI information. As such, when a locating operation for the POI information is requested, the amount of operations for locating the handheld device may be reduced and processing thereof may be sped up. Further, the sorting technology with respect to the POI information corresponding to the POI may be performed based on an attribute district of the POI. A plurality of sets of POI information thus obtained may be compressed to a single set of POI information so that the total information stored in the handheld device may be reduced.

### CROSS-REFERENCE TO RELATED APPLICATIONS

This non-provisional application claims priority under 35 U.S.C. § 119(a) on patent application No. 94106864 filed in Taiwan, R.O.C. on Mar. 7, 2005, the entire contents of which are hereby incorporated by reference.

### BACKGROUND OF THE INVENTION

1. Field of Invention

The invention relates to a data structure for information for a point of interest (POI information) and a method of use and application of a set of POI information with data structure.

2. Related Art

Cell phones are among the most popular handheld devices. Efforts have been made in the development of the functions in cell phones so that they are more convenient to use.

For example, maps may be provided in the cell phones so that users do not need to bring maps on trips. Also, there is a trend of incorporating the global positioning system (GPS) into the maps provided in the cell phones. With these functions, users may be provided with a guide of how to choose travel paths and can see the layout of streets at a specific district by browsing the map. The map may also be provided with information of a point of interest (a set of POI information) so that the users may also find some specific locations and information associated therewith.

Until now, the above mentioned functions have been only directly obtained in the cell phones and personal digital assistants (PDAs) from associated software in computers. However, since the computers may store and run a huge amount of information associated with maps and use them in navigation because of better resolution, processor operation and memory capacity, as compared to the cell phones, the map-associated software may not be suitable for use in cell phones. Further, although there is some information of a POI provided in the cell phones, it is only provided as an added function of the cell phones with limited information of the POI.

For example, information about all streets on a location may not be displayed concurrently with the lower resolution provided in the cell phone, and only some of the streets and information associated therewith may be displayed, such as textual descriptions, e.g. street names. In this case, the user is only allowed to browse a smaller range within the small map and thus specific locations or some POI information is difficult to locate. And, a longer wait time is required when a relatively large amount of map information or a navigation task is involved. In addition, the memory can be a big issue for the handheld device when it comes to incorporation of the POI information. For these reasons, the current handheld device is only provided with maps with bare POI information. Even if the POI information is provided, only rough or deficient information is included therein. It frequently happens that the users may not locate the desired information.

In addition, the above functions may only be limited in map browsing, path plans or display of POI information within a district. No other convenient functions are provided.

### SUMMARY OF THE INVENTION

An object of the invention is therefore to provide a processing technology with respect to a point of interest (POI) and information associated therewith (POI information) in an electronic map stored in a handheld device by sorting the POI information to obtain sorted information based on attributes of the POI, each set of sorted POI information corresponding to a category, and only processing information in a user-assigned category rather than all the POI information in the map. Based on this, information processing time may be reduced when some POI information is requested by a user of the handheld device. Further, desired information may be directly displayed as compared to the prior art where all the POI information for a specific location has to be displayed so that the user must locate desired information among all the POI information of the location. Since some unnecessary POI information may be omitted in display, a display of a relatively lower resolution may be used in the handheld device for readily browsing the desired POI information. Further, the sorted POI information is easily compressed and thus a storage space is reduced.

Further, with the provision of the sorted POI information, the user may readily arrange a trip to a location when the handheld device is carried in hand by selecting the POI corresponding to the location, selecting a category of “visit time” among the categories having all the POI information and selecting a category of “time spent on the way” among the categories having all the POI information.

Therefore, the invention provides a data structure of POI information for a plurality of POIs, comprising a location information block and an attribute information block. The location information block comprises a plurality of location names. The attribute information block comprises a plurality of sets of district-based POI information, location character-based POI information or a combination of the district and location character-based POI information.

The invention also provides a method for use of POI information of a plurality of POIs in a handheld device. The invention comprises the steps of: displaying a plurality of categories obtained based on an attribute of the POI; receiving at least one instruction each for selecting a category; determining a set of POI information matching the assigned POI information by a user under a last category among the selected categories based on the instruction and the selected categories; displaying the set of POI information on the display of the handheld device; selecting an instruction for verifying the set of POI information; and displaying the verified set of POI information on the display.

The invention also provides a method for application of a plurality of sets of POI information of a plurality of POIs, comprising the steps of: receiving a selection for each of the plurality of sets of POI information for each of the plurality of POIs; receiving information of a point of departure for each of the plurality of POIs; arranging a visit period in time and a time spent on routes among locations associated with the plurality of POI based on a set of location information, a travel time, the set of departure information and a map of a corresponding POI.

### BRIEF DESCRIPTION OF THE DRAWINGS

FIG. 1 is a schematic diagram showing a user interface on which categories comprising sorted information of a point of interest (POI information) are sorted based on the theme of the POI according to the invention;

FIG. 2 is a schematic diagram showing a user interface on which categories comprising sorted POI information are sorted based on the district of the POI according to the invention;

FIG. 3 through FIG. 5 are schematic diagrams showing lower-leveled categories comprising sorted POI information sorted based on a specific attribute of the POI, respectively, according to the invention;

FIG. 6 and FIG. 7 are schematic diagrams of displaying of a map associated with the POI or a textual description associated with the POI, respectively, according to the invention;

FIG. 8 is a schematic diagram illustrating a call being made to a telephone number associated with the POI according to the invention;

FIG. 9 is a schematic diagram showing a selection list through which a user determines if all POI information for all locations on a map should be displayed through a map description or a textual description according to the invention;

FIG. 10 is a schematic diagram showing the textual description with respect to the POI information of all locations in the map;

FIG. 11 is a schematic diagram illustrating displaying of a travel plan recommendation; FIG. 12 is a schematic diagram showing information of travel spots and schedules with respect to a travel theme or plan;

FIGS. 13A, 13B and 13C are a set of travel spot information, a travel spot description and a representative photograph for one of the travel spots in the travel theme or plan, respectively; and

FIG. 14 is a schematic diagram showing a selection interface for a custom order function.

### DETAILED DESCRIPTION OF THE INVENTION

The structural features and efficacy of the preferred embodiments of the invention are described in conjunction with the appended drawings.

First, the invention provides a data structure of information about a point of interest (POI information) on an electronic map provided in a handheld device. In essence, the data structure of the POI in the handheld device in the invention is obtained by sorting POI information based on attributes of the POI. For example, attributes such as district and theme (e.g. food, clothing, housing, transportation, education and recreation) may be relied on in conducting such a sorting task. Preferably, the POI information may be sorted based on the attribute “district.” In this case, when locating some information about some locations, processing of the desired information may be sped up. Preferably, the attributes “district” and “theme” may be used concurrently in a POI information locating task. In this case, the amount of information processed and displayed is reduced.

The following is the method of the sorting technology provided in the invention:

(1) assigning information of an attribute of the POI into a category, each attribute corresponding to a category, (2) presenting the attribute onto a file name (e.g., 01xxx.poi represents Taipei, Taiwan, 02xx.poi represents Taoyuan, Taiwan and the like) and (3) including the attributes into the POI information. The sorting method described above may be adopted alone or any combination thereof may be otherwise used. In this manner, the information of a specific location may be located only within the information of a desired attribute but not over all the POI information for the POI in the map. Further, storage positions of all POI information in a category for each POI may be established in a POI information storage position pointing table (abbreviated as “storage location pointing table” hereinbelow). When a set of POI information is to be located from the handheld device based on a specific attribute of a specific POI (determined by the user), a storage position of the set of information of the specific attribute may be located on the storage location pointing table. With the storage position, the POI information of the attribute is then located and read. Further, a plurality of sets of POI information corresponding to an attribute (i.e. under a same category) may be compressed into a POI file (so as to save storage space) and the desired POI information may be located rapidly by means of the storage position pointing table.

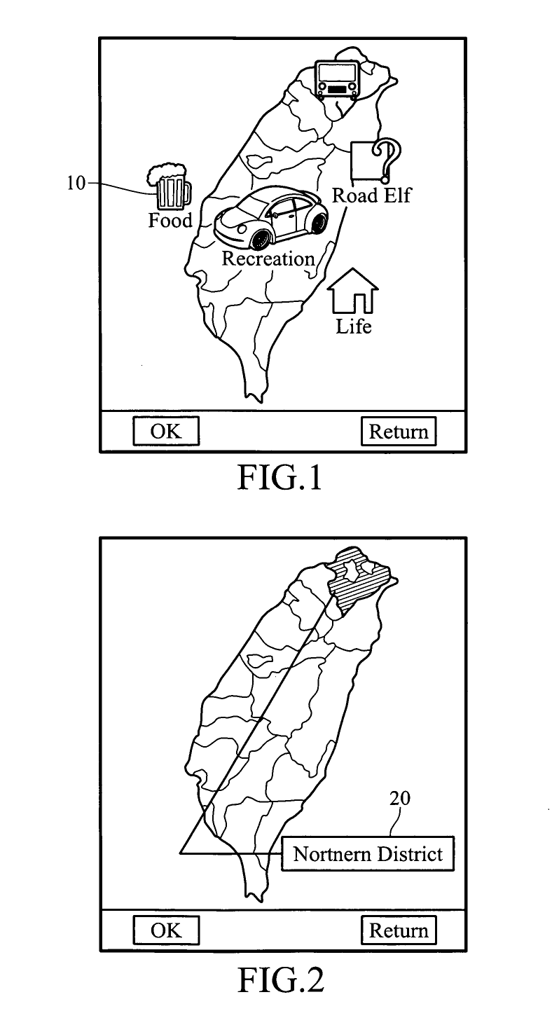

Specifically, the data structure comprises a location information block and an attribute information block. The location information block comprises a plurality of sets of POI information, such as location names, addresses, telephone numbers, photograph information and the like. The attribute information block comprises a plurality of sets of district-categorized POI information, location character categorized POI information and theme-categorized POI information. On the display of the handheld device, the POI information for each POI stored therein is displayed based on such a data structure. In FIG. 1 and FIG. 2, for example, information sorted based on theme and district of a POI are located under each category corresponding to the attributes “theme” and “district,” respectively, and these categories are shown. In locating a set of desired POI information, the user may select one of the categories based on the attribute theme of the POI in a selection page on a display of the handheld device, shown in FIG. 1. After the first selection, a next selection page of categories provided based on the attribute “district” or a set of POI information under the selected category is shown.

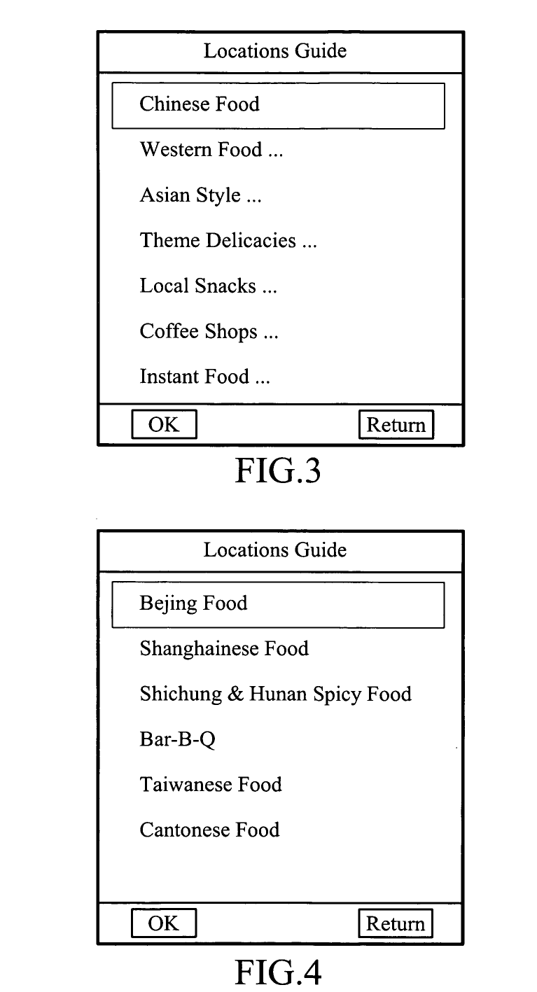

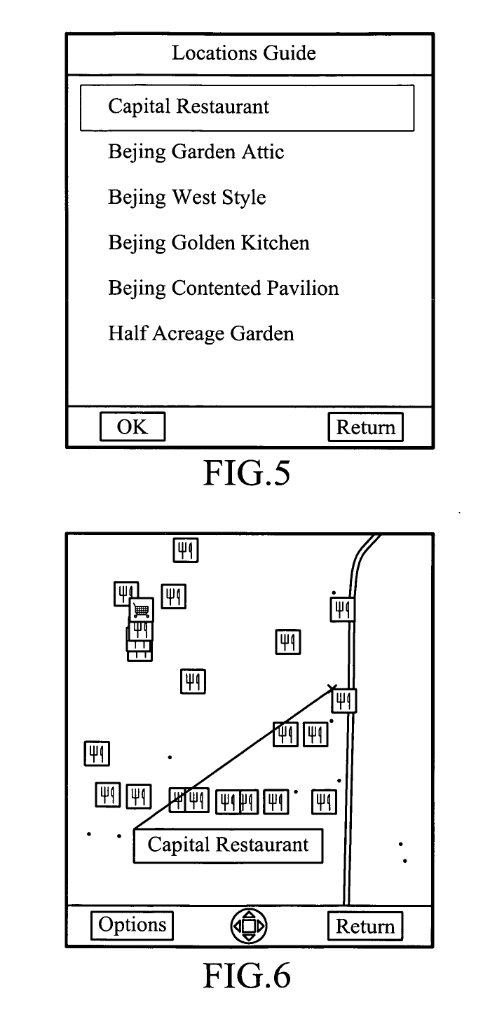

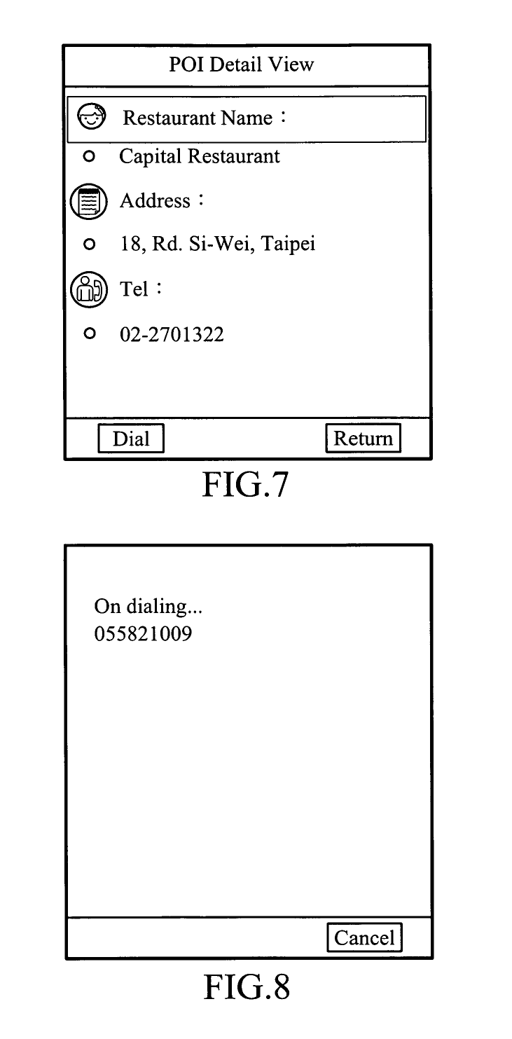

Now, an example as to locating and displaying POI information is described. First, the user selects a category “Food” 10 at a selection page showing six categories of the POI information, shown in FIG. 1. Next, a next selection page corresponding to the attribute “district” is displayed, as shown in FIG. 2. On the selection page, the user selects a category “Northern District” 20. Then, a selection page corresponding to an attribute “restaurant type” is displayed, as shown in FIG. 3. The user selects a category “Chinese Food Restaurant.” Thereafter, a selection page corresponding to an attribute “food type” is displayed, as shown in FIG. 4. After the user selects a category “Bejing Food,” all restaurants under the category are listed, as shown in FIG. 5. Then, the user selects a restaurant from the list under the last category and the display shows a map associated with the restaurant (shown in FIG. 6) or textual information of the restaurant (including restaurant name, address, telephone number, etc., shown in FIG. 7). Finally, the user may click on an icon corresponding to the restaurant so that he or she may make a call to the restaurant to make a reservation or ask a question, as shown in FIG. 8. Specifically, the method for use of POI information of a plurality of POIs in a handheld device having a display comprises the steps of: displaying a plurality of categories obtained based on attributes of the POI; receiving at least one instruction for selecting a category; determining a set of POI information matching the assigned POI information under a last category among the selected categories based on the instruction and the selected categories; displaying the set of POI information on the display of the handheld device; selecting an instruction for verifying the set of POI information; and displaying the verified set of POI information on the display.

Although the above embodiment is described with the POI information sorted based on attributes of four levels for the locating of the specific POI information, the number of the attribute levels should be determined according to the amount of POI information. After the selection of the desired POI information through the attribute-level sorted information in each level, the located POI information is reduced so that less POI information is processed for the desired POI information. Further, the user may directly input an instruction for listing all the POI information at any attribute level without acquiring the categories of the subsequent attribute level. As a specific example, the user may make a setting so that all sets of the located POI information may be displayed when the number of the sets of POI information is less than, for example, 20.

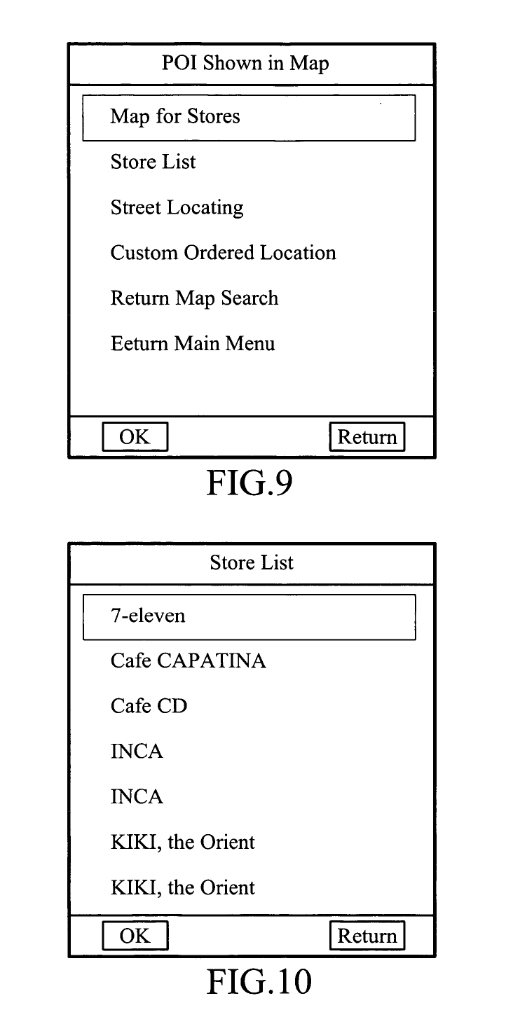

Referring to FIG. 9, all stores founded in the map associated with the restaurant may be displayed in a plurality of sets of POI information. To see the plurality of sets of POI information of each of the stores, the user may switch between a page showing a map associated with the store and a page showing a textual description so that all the POI information for the store may be seen in a form of the map or textual description (see FIG. 10). Further, since the display of the handheld device does not provide sufficient resolution with respect to all the POI information of all locations in the map associated with the restaurant, such as location names, the invention provides a location switching function, which may also be executed directly on the map associated with the restaurant. As such, the POI information with respect to all the stores on the map associated with the restaurant may be switched to display. Further, the user may input an instruction at any time for requesting display of POI information with respect to a location near the restaurant in the map associated with the restaurant. As such, all the POI information of the locations on the map associated with the restaurant may be displayed by accessing the map associated with the restaurant directly.

Now, a user interface to the locating operation of the POI information in the handheld device is described. Referring to FIG. 1, in addition to the categories obtained based on an attribute of POIs such as “MRT,” “food,” “recreation” and “life,” the categories “Road Elf” and “Travel Collection” are also displayed on the page shown in FIG. 1. The category “Road Elf” provides the functions of map browsing and road and location searching, and the category “Travel Collection” provides the function of travel arrangements. With the category “Road Elf,” the user may directly browse a specific location on an associated map. However, this is not in the way mentioned above where POI information of a specific location is acquired in a POI information form. When the specific location is browsed on the map, the user may initialize the searching function (corresponding to function items of street searching and location assigned) through which the user inputs a keyword and the information matched with the keyword is displayed.

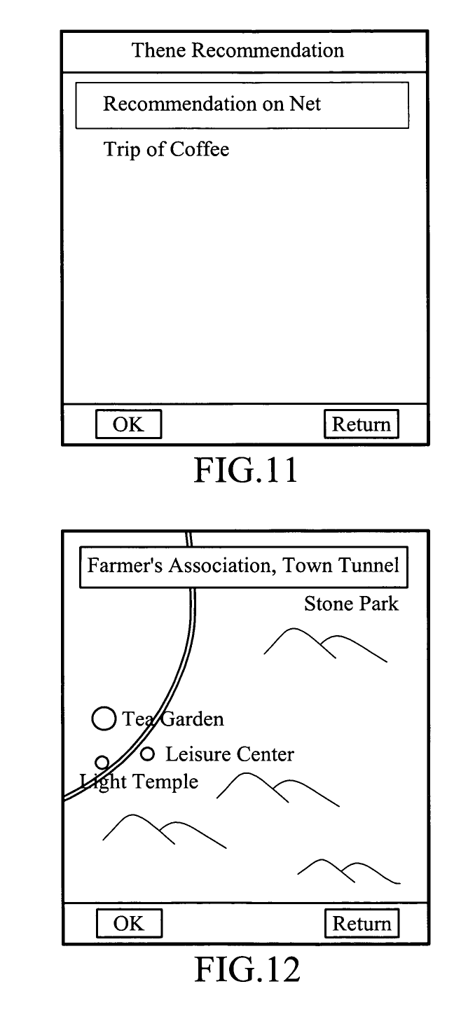

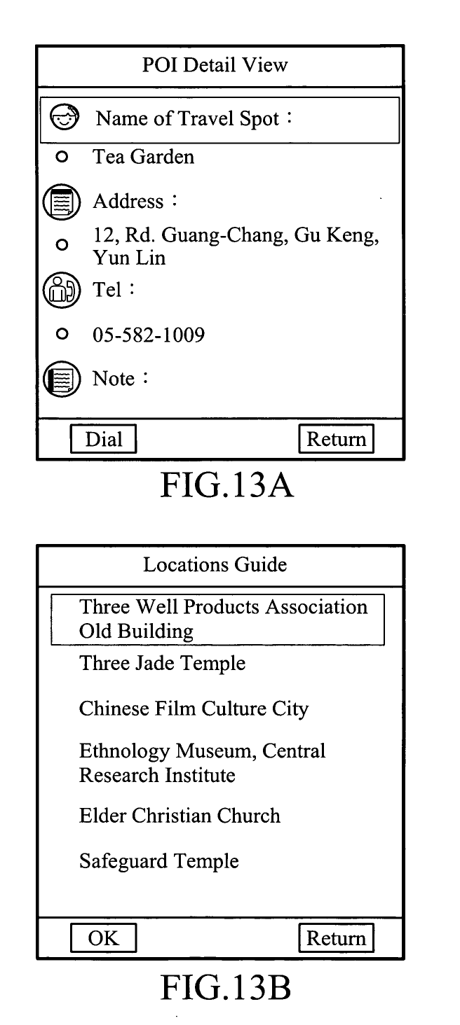

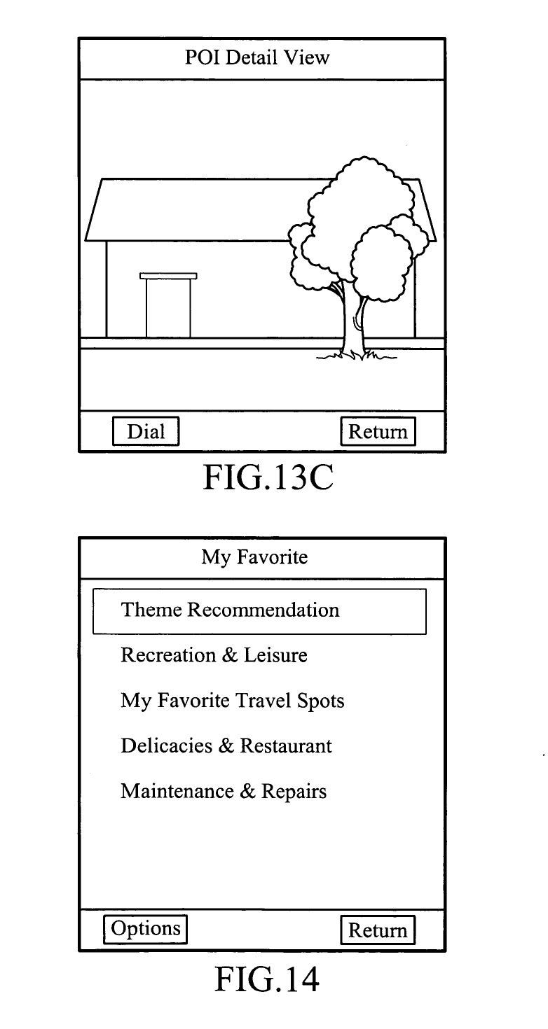

As related to the category “Travel Collection,” a multiplicity of locations in the form of a plurality of sets of POI information may be connected. When the category is entered, a travel theme or package recommendation is made and displayed, as shown in FIG. 11. When a travel theme or package is selected, a travel schedule and travel spots involved in the travel theme or package are displayed, as shown in FIG. 12. When the travel spots are selected, POI information of each of the travel spots is displayed in detail, comprising travel spot POI information, a travel spot description and a representative photograph, shown in FIG. 13A, FIG. 13B and FIG. 13C, respectively. In the page associated with the travel spot information, features of the travel spot are also described. This helps the user determine whether to select the current travel spot or not.

Furthermore, the invention also provides a function of custom ordering with respect to travel spots included in a travel plan. In using such a function, a selection interface is used first when the POI information is browsed, as shown in FIG. 14. The POI information of the travel spots may be added into the category “My favorite travel spots.” For the POI information of the travel spots, information of travel time (e.g. an appropriate visit time) and other information of the travel spot is included. When all custom ordered travel spots are set, a travel plan is automatically formed according to the purported travel spots. In the travel plan, information of distances and corresponding transportation times among travel spots, appropriate travel times (a beginning time, an end time and a required time for each visit) for these travel spots and the like is provided. Then, the user can adjust the travel plan according to his or her desire, e.g. changing the sequence of the travel spots obtained automatically, adding one or more travel spots, or deleting any of the travel spots obtained automatically. Further, the user can adjust the travel plan by changing the travel time for each of the travel spots. In addition, restaurants that the user wishes to visit may also be included in the category “My Favorite Travel Spots.” The POI information under the category “Food” also comprises information of an appropriate dinner time (the appropriate visit time) and an appropriate dinner period in time (the appropriate length of visit time) and the like. In addition, the software processing the POI information in the handheld device may also set automatically the appropriate visit time for each of the travel spots based on one or more specific attribute thereof. For example, a visit time for a restaurant is assigned at the dinner time, a visit time for a mountain trail is assigned at a morning time or an afternoon time, and a visit time for a pub is assigned at a night time. In addition, a travel spot may be automatically defined when some certain condition taken place. For example, a petrol station near a travel spot or a route between travel spots in the travel plan is automatically defined as a travel spot so that the car may be fueled.

In conclusion, the method for application of a plurality of sets of POI information comprises the steps of: receiving a selection for each of the plurality of sets of POI information for each POI; receiving information of a point of departure for each of the plurality of POIs; and arranging a visit time and a time spent on routes among locations associated with the plurality of POIs based on a set of location information, a travel time, departure information and a map of a corresponding POI so as to form a travel plan.

As above mentioned, the POI information stored in the handheld device is sorted based on the attributes of a POI so that locating and displaying the POI information may be sped up. With the provision of the user interface for the locating operation and the method for use of the POI information, the POI information may be used more conveniently and located more easily. Further, the sorting technology with respect to the POI information may be applied to the custom order function with respect to a travel plan. As such, the electronic map and the POI information on the handheld device may be used to a greater extent.

As described above, the sorted POI information (in the format of the data structure provided by the invention) essentially speeds up the POI information locating and displaying processes. Further, the user interface for the locating operation of the POI information and the method for use of the POI information facilitate location of the POI information in the handheld device. Moreover, the sorted POI information may be applied to the function of a custom ordered travel plan.

While embodiments and applications of the invention have been shown and described, it will be apparent to those skilled in the art having the benefit of this disclosure that many more modifications than mentioned above are possible without departing from the inventive concepts herein. The invention, therefore, is not to be restricted except in the spirit of the appended claims and their equivalents.

What is claimed is:

1. A data structure of information about a point of interest (POI) (POI information), comprising:
a location information block comprising a plurality sets of POI information each comprising a plurality sets of location name; and
an attribute information block comprising a plurality sets of district-categorized POI information and a plurality sets of location character categorized POI information and a combination thereof.

2. The data structure according to claim 1, wherein the location information block further comprises a plurality sets of address, telephone number, photograph and travel time-categorized POI information, respectively, and a combination thereof.

3. The data structure according to claim 2, wherein each of the plurality sets of location character-categorized POI information comprising a set of food, clothing, housing, transportation, education and recreation-categorized POI information, respectively, and a combination thereof.

4. The data structure according to claim 1, wherein a plurality sets of the POI information categorized based on a specific attribute of the POI are compressed into a POI information file.

5. The data structure according to claim 4, wherein a storage position of each of the plurality of sets of the POI information is pointed by a set of storage position pointing information in a storage position pointing table.

6. The data structure according to claim 4, wherein the POI information file has a file name comprising a set of sorted POI information comprising a set of district-categorized, location character-categorized POI information.

7. The data structure according to claim 4, wherein the file name in a directory in which the POI information file is stored comprises a set of district-categorized and a set of location character-categorized POI information, respectively.

8. The data structure according to claim 1, wherein the location information block comprises a plurality sets of location description information.

9. A method for use of POI information of a plurality of POIs in a handheld device having a display, comprising the steps of:
displaying a plurality of categories each based on a specific attribute of the POIs;
receiving at least an instruction each for selecting a category;
determining a set of POI information mating with an assigned POI information by a user under the selected categories based on the at least the instruction and the selected categories and displaying the set of POI information on the display of the handheld device;
selecting an instruction for verifying the set POI information; and
displaying the set of POI information as verified on the display.

10. The method according to claim 9, wherein the plurality of categories comprises food, clothing, housing, transportation, education and recreation-based categories and a combination thereof.

11. The method according to claim 9, further comprising the steps of:
reading a set of storage position pointing information from a storage position pointing table based on the assigned POI information.

12. The method according to claim 9, further comprising the steps of:
making a call to a recipient corresponding to the display POI information having a specific telephone number.

13. The method according to claim 9, further comprising the steps of:
receiving an instruction for switching the displayed POI information between a map description and a textual description.

14. The method according to claim 13, further comprising the steps of:
receiving an instruction for listing at least a set of POI information corresponding to locations within the map description corresponding to the displayed POI information.

15. The method according to claim 14, further comprising the steps of:
receiving an instruction for switching among the at least the set of POI information corresponding to the locations within the map description corresponding to the displayed POI information.

16. A method for application of a plurality sets of POI information of a plurality of POIs, comprising the steps of:
receiving a selection for each of the plurality sets of POI information for each of the plurality of POIs;
receiving information of a point of departure for each of the plurality of POIs; and
arranging a visit period in time and a time spent on routes among locations associated with the plurality of POI, respectively, based on a set of location information, a travel time, the set of departure information and a map of a corresponding one of the plurality of POIs for each of the plurality of POIs, respectively, so as to form a travel plan.

17. The method according to claim 16, wherein the travel time comprises an appropriate visit time, a visit time and a combination thereof.

18. The method according to claim 17, wherein the plurality sets of POI information comprises at least a set of food-categorized POI information, and the appropriate visit time of the food-categorized POI information is an appropriate dinner time and the visit period in time is a dinner period in time.

19. The method according to claim 16, further comprising the steps of:
receiving an instruction for adjusting the travel plan by adjusting a sequence and the visit period in time of each of the plurality POIs so as to rearrange the travel plan.

20. The method according to claim 16, further comprising the steps of:
receiving a condition for a visit for an additional POI and including automatically the additional POI into the travel plan.

21. The method according to claim 20, wherein the set of food-categorized POI information is a petrol station and the condition is a distance from the petrol station.

22. A user interface of information about a plurality of points of interest (POIs) (a plurality sets of POI information) each categorized based on a specific attribute of the POI into a plurality sets of categorized information, comprising:
a plurality of category blocks each coupled to a corresponding one of the plurality sets of categorized information and each providing a plurality sets of POI information mating with the category; and
a map displaying block providing a plurality of electronic maps each for a corresponding one of the plurality of the POIs.

23. The user interface according to claim 22, each of the plurality sets of POI information further comprises a set of travel schedule arrangement POI information.

24. The user interface according to claim 23, further comprising: a travel schedule arrangement area couple to the set of travel schedule arrangement POI information for all the POIs.
